(19) United States
(12) Patent Application Publication
(10) Pub. No.: US 2006/0101615 A1
(43) Pub. Date: May 18, 2006

(54) Flexible stop buffer, particularly for cover lids

(75) Inventors: Wilfried Pinzl, Tambach-Dietharz (DE); Uwe Rausch, Tambach-Dietharz (DE); Eberhard Christ, Tambach-Dietharz (DE)

Correspondence Address: BIRCH STEWART KOLASCH & BIRCH, PO BOX 747, FALLS CHURCH, VA, 22040-0747, US

(73) Assignee: EJOT GmbH & Co. KG

(21) Appl. No.: 11/274,287

(22) Filed: Nov. 16, 2005

(30) Foreign Application Priority Data
Nov. 18, 2004 (DE) 10 2004 055 638.5

(51) Int. Cl. E05F 5/02

(52) U.S. Cl. 16/82

(57) ABSTRACT

The invention relates to a flexible stop buffer, particularly for cover lids, with a buffer stem and a buffer head, said buffer head being axially displaceable and being slipped over the buffer stem, wherein disposed between buffer stem and buffer head in the interior space of the latter is a buffer spring, said buffer spring pressing the buffer head away from the buffer stem, and wherein the buffer head is secured by means of locking lugs against being pulled off the buffer stem. The buffer head is provided, inside an interior space surrounded by the locking lugs, with an axial projection, from which axial projection anti-rotation elements on the buffer stem are adapted to be brought into engagement with the buffer head.

The invention relates to a flexible stop buffer, particularly for cover lids, with a buffer stem and a buffer head, said buffer head being axially displaceable and being slipped over the buffer stem, wherein disposed between buffer stem and buffer head in the interior space of the latter is a buffer spring, said buffer spring pressing the buffer head away from the buffer stem, and wherein the buffer head is secured by means of locking lugs against being pulled off the buffer stem.

Such a stop buffer is disclosed in European patent application 1 300 290 A2. The two constituent parts of said stop buffer, its buffer stem and its buffer head, are, before the stop buffer is inserted with its buffer stem into any component, assembled in that the buffer head is slipped over the relevant end of the buffer stem, a secure connection between the two constituent parts being ensured by means of locking lugs. To enable the stop buffer to be secured by means of its threaded buffer stem to the component by means of screwing in, the buffer stem is provided at its end surrounded by the buffer head with a tool-accepting recess, e.g. a hexagonal socket, which serves to accept a correspondingly shaped tool used for securing the buffer stem together with the buffer head to the component. In order to ensure that, also with the buffer head slipped on in position, the tool-accepting recess remains accessible for said securing operation, the buffer head is provided on its side facing the relevant end of the buffer stem with such a large opening that the screwing tool which engages the hexagonal socket can conveniently be introduced through said opening.

A similar design of a flexible stop buffer is described in German patent specification 195 20 492 C2, in which, in contrast to a helical spring, a pressure chamber imparts the desired flexibility, wherein, with a piston projecting out of the buffer head and in cooperation with the pressure chamber, the air contained in the pressure chamber imparts, more or less with pressure on the buffer head, a flexible support thereto. Furthermore, in the aforementioned publication, the buffer stem is provided with axial grooves which are engaged by radial projections associated with the buffer head, this providing the buffer head with the necessary axial guidance with respect to the buffer stem. The securing of the buffer stem to a component is accomplished by means of snap-action hooks provided on the buffer stem, said snap-action hooks engaging behind a component to which the stop buffer is to be attached.

With the initially mentioned stop buffer, it is necessary to reach through the buffer head using a turning tool in order to act on the buffer stem in cases where the buffer stem is threaded. The through-hole in the buffer head makes the interior space below the buffer head with the buffer spring accessible from outside, with the result that, especially when an object impacts on the buffer head, it is possible for dirt and foreign bodies to enter into the interior space, said dirt and foreign bodies then being able to have an adverse effect on the correct functioning of the stop buffer in the case of relative motion between buffer head and buffer stem, said interior space being difficult to access, with the consequence that the cleaning of said interior space is virtually impossible.

The object of the invention is to design the initially described stop buffer such that the interior space below the buffer head is and remains virtually inaccessible while, however, the axial mobility of the buffer head with respect to the buffer stem is not adversely affected and the entire stop buffer can be inserted, more particularly screwed, via the buffer head into a hole of a component. The object of the invention is achieved in that the buffer head is provided, inside an interior space surrounded by the locking lugs, with an axial projection, from which axial projection anti-rotation elements on the buffer stem are adapted to be brought into engagement with the buffer head.

Owing to this design, no through-hole is required for the buffer head, with the result that the buffer head extensively shields the interior space of the stop buffer against the ingress of impurities. When the buffer head is rotated, it co-rotates the buffer stem on account of the provided rotation-locking means, as a result of which the buffer stem can be screwed into any component. Direct action on the buffer stem from outside in the sense of a rotary motion is not necessary, because, when the buffer head is rotated, the anti-rotation elements provided on the buffer stem act as a rotation-locking means between buffer head and buffer stem while, on the other hand, when the buffer head is rotated, said anti-rotation elements co-rotate the buffer stem accordingly.

Advantageously, the axial projection in the buffer head is in the form of a coaxial annular part which engages a coaxial sleeve on the buffer stem. A further possibility for the locking of buffer head and buffer stem is provided by a design in which the axial projection in the form of a central rectangular projection engages a specially shaped metal piece, said specially shaped metal piece being in the form of a laterally open box and forming the buffer stem, wherein said specially shaped metal piece, with retaining walls and transversely extending beads, engages axial hollow spaces in the buffer head.

For the axial locking of buffer head and buffer stem, the annular part and the sleeve can each be provided with annular shoulders, said annular shoulders forming the locking lugs and being directed against each other.

For securing of the stop buffer by means of the buffer stem, it is possible above all to employ a thread, for which purpose the stop buffer is of such design that the buffer stem terminates in a screw. Alternatively, however, it is possible for the buffer stem to be provided with expanding springs and locking catches, with the result that the stop buffer is able simply to be pressed into a corresponding recess in a component and thereby be locked in position.

There are several design possibilities for the buffer spring. Firstly, it is possible for the buffer spring to be in the form of a helical spring. Secondly, it is also possible for a flexible plastic part to be employed as the buffer spring.

If a specially shaped metal piece is used as the axial projection, said specially shaped metal piece can also be used to act as the buffer spring, for which purpose the specially shaped metal piece is provided with diagonal spring arms, said spring arms cooperating with inclined surfaces on the projection. Under the action of the diagonal spring arms, which press on the inclined surfaces on the projection, it is ensured that the buffer head is pressed away from the buffer stem by means of the specially shaped metal piece, this resulting in axial flexibility because of the inclined surfaces.

Illustrative embodiments of the invention are presented in the drawings, in which:

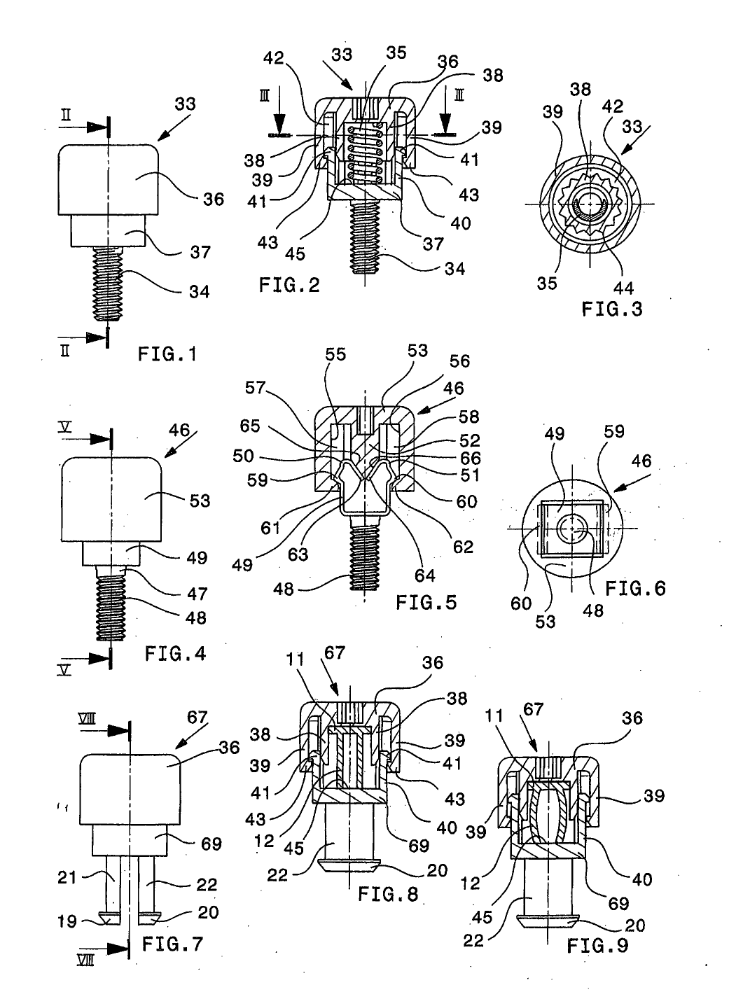

FIG. 1 shows the stop buffer in a side view with a threaded buffer stem;

FIG. 2 shows the same stop buffer in a section along line II-II from FIG. I with a helical spring as the buffer spring; FIG. 3 shows a section along line III-III from FIG. 2; FIG. 4 shows a side view of another design of the stop buffer; FIG. 5 shows a section through the same stop buffer along line V-V from FIG. 4 with a buffer stem formed by a specially shaped metal piece;

FIG. 6 shows the stop buffer from FIG. 4 in a view looking onto the buffer stem;

FIG. 7 shows a stop buffer in a side view with expanding springs for attachment to a component;

FIG. 8 shows the same stop buffer in a section along line VIII-VIII from FIG. 7 with a buffer spring formed by a flexible plastic part;

FIG. 9 shows the stop buffer from FIG. 8 with the plastic part partially compressed.

The stop buffer 33 presented in FIG. 1 to 3 is a stop buffer which is provided with a threaded stem 34 and a helical spring 35 as the buffer spring. In this case, the locking of buffer head 36 and buffer stem 37 is accomplished in that the buffer head 36 transitions into the annular wall 39 in which the free annular space 42 remains free on the inside. Projecting into said annular space 42 is the coaxial sleeve 40 of the buffer stem 37, said coaxial sleeve 40 engaging the annular shoulders 43 with its locking lugs in the form of annular shoulders 41, thereby establishing the connection between buffer head 36 and buffer stem 37. In order to ensure that buffer head 36 and buffer stem 37 cannot rotate independently of each other, the coaxial annular part 38 is provided with externally pointing teeth 44 (see FIG. 3) which engage mating teeth on the inside of the coaxial sleeve 40. The buffer spring 35 presses, at one end, from inside against the buffer head 36 and, at the other end, against the base 45 of the coaxial sleeve 37, wherein said coaxial sleeve 37 with the base 45 completely closes off the interior space of the stop buffer 33 against the outside. Consequently, it is not possible for any dirt or dust to penetrate into the interior space.

The stop buffer 46 shown in FIG. 4 to 6 (FIG. 6 showing a view of threaded portion 48, FIG. 5 showing a section along line V-V from FIG. 4) has a buffer stem 47 with the threaded portion 48 and the specially shaped metal piece 49, wherein, in the manner of a laterally open box, said specially shaped metal piece 49 with its retaining walls 50 and 51 embraces the central rectangular projection 52, which projection 52, as a constituent part of the buffer head 53, projects into the interior space of the buffer head 53. The outside wall of the buffer head 53 is in the form of a hollow cylinder which, however, is provided in its interior with the two surfaces 55 and 56 which face each other parallel to the retaining walls 50 and 51 of the specially shaped metal part 49. Consequently, the buffer head 53 contains two hollow spaces 57 and 58 which extend with parallel walls transversely through the buffer head 53 and which contain the retaining walls 50 and 51. The retaining walls 50 and 51 each have transversely extending beads 59, 60 which are supported against likewise transversely extending counter-bearings 61 and 62, this preventing the buffer stem 47 from falling off the buffer head 53 after the buffer stem has been inserted. In this connection, the parallel nature of the interior spaces 57 and 58 with the transversely and rectilinearly extending beads 59, 60 ensures that, taking into consideration the rectangular cross section of the projection 52, the inserted buffer stem 47 is unable to rotate with respect to the buffer head 53.

In addition, the specially shaped metal piece 49 is used to act as the buffer spring, for which purpose the two spring arms 63 and 64 are pressed out of the specially shaped metal piece 49, said spring arms 63 and 64 coming up against the corresponding inclined surfaces 65, 66 on the projection 52 and, on account of their inclined position and spring characteristics, pressing the projection 52 and therefore the buffer head 53 away from the buffer stem 47. The two spring arms 63, 64 act in identical manner to the helical springs and the flexible plastic part 11 mentioned in connection with the previously described illustrative embodiments.

The stop buffer 67 presented in FIG. 7 to 9 (FIG. 8 showing a section along line VIII-VIII from FIG. 5) has the locking catches 19, 20 for securing the stop buffer to a component (not shown), for which purpose the stop buffer 67 is pressed into a corresponding recess, wherein, because they are attached to the expanding springs 21 and 22, the locking catches 19 and 20 are compressed inwardly and spring back outwardly.

As illustrated in FIG. 8, the flexible plastic part 11 is inserted in the interior space of the annular part 38 on the buffer head 36, wherein the buffer head 36 can be pressed onto said flexible plastic part 11, as a result of which the flexible plastic part 11 with its cylindrical portion 12 is compressed and, on account of its elasticity, presses the buffer head 36 away from the buffer stem 69.

The elastic deformation of the cylindrical portion 12 is presented in FIG. 9, which, in comparison with FIG. 8, shows the stop buffer 67 in a position in which the buffer head 36 has been displaced towards the buffer stem 69. During this displacement through pressure on the buffer head 36, the annular shoulders 41 move away from the inwardly pointing radial projection 43, wherein, at the same time, the cylindrical portion 12 arches outwardly, pressing itself with corresponding spring tension against the buffer head 36.

1. Flexible stop buffer (33, 46), particularly for cover lids, with a buffer stem (37, 49) and a buffer head (36, 53), said buffer head (36, 53) being axially displaceable and being slipped over the buffer stem (37, 49), wherein disposed between buffer stem (37, 49) and buffer head (36, 53) in the interior space of the latter is a buffer spring (35; 50, 51), said buffer spring (35; 50, 51) pressing the buffer head (36, 53) away from the buffer stem (37, 49), and wherein the buffer head (36, 53) is secured by means of locking lugs (43, 61, 62) against being pulled off the buffer stem (37, 49), characterized in that the buffer head (36, 53) is provided, inside an interior space surrounded by the locking lugs (43; 61, 62), with an axial projection (38, 52), from which axial projection (38, 52) anti-rotation elements (44; 50, 51; 59, 60) on the buffer stem (37, 49) are adapted to be brought into engagement with the buffer head (36, 53).

2. Stop buffer according to claim 1, characterized in that the axial projection in the form of a coaxial annular part (38) engages a coaxial sleeve (40) on the buffer stem (37).

3. Stop buffer according to claim 1, characterized in that the axial projection in the form of a central rectangular projection (52) engages a specially shaped metal piece (49), said specially shaped metal piece (49) being in the form of a laterally open box and forming the buffer stem, wherein said specially shaped metal piece (49), with retaining walls (50, 51) and transversely extending beads (59, 60), engages axial hollow spaces (57, 58) in the buffer head (53).

4. Stop buffer according to claim 1, characterized in that, for the locking of buffer head (36) and buffer stem (37), the annular part (38) and the sleeve (40) are each provided with annular shoulders (41, 43), said annular shoulders (41, 43) forming the locking lugs and being directed against each other.

5. Stop buffer according to claim 1, characterized in that the buffer stem (37, 49) terminates in a screw (34, 48).

6. Stop buffer according to claim 1, characterized in that the buffer stem (37) is provided with expanding springs (21, 22), said expanding springs (21, 22) terminating in locking catches (19, 20).

7. Stop buffer according to any claim 1, characterized in that the buffer spring is in the form of a helical spring (35).

8. Stop buffer according to claim 1, characterized in that the buffer spring is formed by a flexible plastic part (11).

9. Stop buffer according to claim 1, characterized in that the buffer spring is formed by the specially shaped metal piece (49), said specially shaped metal piece (49) being provided with diagonal spring arms (63, 64), said spring arms (63, 64) cooperating with inclined surfaces (65, 66) on the projection (52).
